(19) United States
(12) Patent Application Publication
(10) Pub. No.: US 2026/0149999 A1
(43) Pub. Date: May 28, 2026

(54) CONTROL METHOD AND APPARATUS THEREOF

(71) Applicant: BEIJING XIAOMI MOBILE SOFTWARE CO., LTD., Beijing (CN)

(72) Inventors: Jinhua WU, Beijing (CN); Yang SHEN, Beijing (CN); Jianfeng QI, Beijing (CN)

(21) Appl. No.: 19/114,627

(22) PCT Filed: Sep. 26, 2022
(86) PCT No.: PCT/CN2022/121510

§ 371 Date: Mar. 24, 2025

(51) Int. Cl. H04W 28/02; H04M 15/00; H04W 28/24

(52) U.S. Cl. CPC H04W 28/0268; H04M 15/66; H04W 28/24

(57) ABSTRACT

A control method includes: receiving an assistance operation rule sent by a first network device to the UE; and assisting in performing quality of service (QoS) control on at least one of an uplink or a downlink of the UE according to status information of the UE and the assistance operation rule.

### CROSS-REFERENCE TO RELATED APPLICATION

The present application is a U.S. national phase of International Application No. PCT/CN2022/121510, filed with the State Intellectual Property Office of P. R. China on Sep. 26, 2022, the contents of which are incorporated herein by reference in their entireties for all purposes.

### TECHNICAL FIELD

The present disclosure relates to the field of communication technology, and specifically to a control method and apparatus.

### BACKGROUND

Mobile media service, extended reality (XR) service, cloud gaming, video-based machine or drone remote control, and other services are expected to require mobile communication networks to provide increasingly higher traffic. In addition to audio and video streams, these services also involve multimodal data streams, such as data streams of biotactile perception. These multimodal data streams often have differentiated uplink/downlink requirements based on different service characteristics or usage scenarios.

Effectively identifying and utilizing these characteristics will be more helpful for network transmission and control, and also more helpful for service guarantee.

### SUMMARY

According to a first aspect of the embodiments of the present disclosure, a control method is provided, performed by a UE, including:
receiving an assistance operation rule sent by a first network device to the UE; and
assisting in performing quality of service (QoS) control on an uplink and/or a downlink of the UE according to status information of the UE and the assistance operation rule.

According to a second aspect of the embodiments of the present disclosure, a control method is provided, performed by a first network device, including:
sending an assistance operation rule to a user equipment (UE), in which the assistance operation rule is used for the UE to assist in performing quality of service (QoS) control on an uplink and/or a downlink of the UE according to status information of the UE.

According to a third aspect of the embodiments of the present disclosure, a control method is provided, performed by a second network device, including:
receiving a policy and charging control (PCC) rule sent by a first network device, in which the PCC rule includes an assistance operation rule; and
sending the assistance operation rule to a user equipment (UE), in which the assistance operation rule is used for the UE to assist in performing quality of service (QoS) control on an uplink and/or a downlink of the UE according to status information of the UE.

### BRIEF DESCRIPTION OF THE DRAWINGS

In order to clearly illustrate technical solutions of the embodiments and the background of the present disclosure, a brief description of drawings used in embodiments and the background is given below.

FIG. 1 is a schematic diagram of a communication system according to an embodiment of the present disclosure;

FIG. 2 is a flowchart of a control method according to an embodiment of the present disclosure;

FIG. 3 is a flowchart of a control method according to an embodiment of the present disclosure;

FIG. 4 is a flowchart of a control method according to an embodiment of the present disclosure;

FIG. 5 is a flowchart of a control method according to an embodiment of the present disclosure;

FIG. 6 is a flowchart of a control method according to an embodiment of the present disclosure;

FIG. 7 is a flowchart of a control method according to an embodiment of the present disclosure;

FIG. 8 is a flowchart of a control method according to an embodiment of the present disclosure;

FIG. 9 is a schematic diagram illustrating an interaction process of a control method according to an embodiment of the present disclosure;

FIG. 10 is a flowchart of a control method according to an embodiment of the present disclosure;

FIG. 11 is a flowchart of a control method according to an embodiment of the present disclosure;

FIG. 12 is a flowchart of a control method according to an embodiment of the present disclosure;

FIG. 13 is a block diagram of a control apparatus 1000 according to another embodiment of the present disclosure;

FIG. 14 is a block diagram of a control apparatus 1100 according to another embodiment of the present disclosure;

FIG. 15 is a block diagram of a control apparatus 1200 according to another embodiment of the present disclosure;

FIG. 16 is a block diagram of a communication apparatus 13000 according to an embodiment of the present disclosure; and

FIG. 17 is a block diagram of a chip according to an embodiment of the present disclosure.

### DETAILED DESCRIPTION

For ease of understanding, the terms involved in the disclosure are introduced firstly.

### XR Service

XR stands for extended reality, which can be translated into Chinese as “ [symbol] ”. The service refers to a collection of technologies such as Virtual Reality (VR), Augmented Reality (AR), and Mixed Reality (MR).

Current communication technologies often use a general quality of service (QoS) mechanism to handle various data services including the XR service, without fully considering characteristics of the XR service and unable to effectively support differentiated uplink/downlink requirements, such as asymmetric requirements for uplink reliability and downlink data bandwidth. Meanwhile, the XR service also has the characteristics of high bandwidth, low latency and high reliability requirement. How to balance the user-perceived quality of the service and the energy consumption of the device is also a direction that needs to be studied.

In order to support transmission of the XR service and multimodal data streams, the related art has studied the energy consumption control in consideration of traffic characteristics of the XR service. However, there is no corresponding standard solution for performing policy and charging control (PCC) policy formulation and QoS control based on status information of a user equipment (UE) in combination with service characteristics of services executed by the UE.

In the embodiments of the present application, it is considered to reduce a QoS level based on the status information of the UE, such as battery level, battery life, power supply mode, and overheating status.

In order to better understand a control method in the embodiments of the present disclosure, a communication system to which the embodiments of the present disclosure are applicable is firstly described as follows.

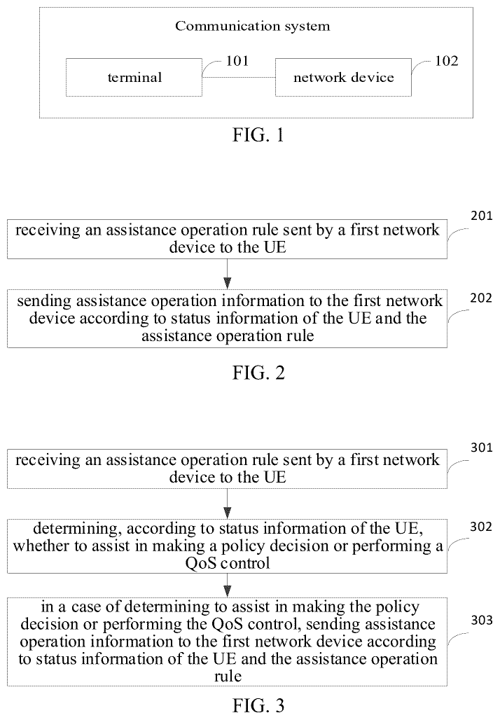

Please refer to FIG. 1, which is a schematic diagram of a communication system according to an embodiment of the present disclosure. The communication system may include, but is not limited to, one network device and one terminal. The number and form of devices shown in FIG. 1 are only shown as an example, and do not constitute a limitation on the embodiments of the present disclosure. The communication system may include two or more network devices and two or more terminals in a practical application. The communication system in FIG. 1 including at least one network device 101 and one terminal 102 is shown as an example.

It should be noted that the technical solution of the embodiments of the present disclosure may be applied to various communication systems, for example, a long term evolution (LTE) system, a 5th generation (5G) mobile communication system, a 5G new radio (NR) system, or other new mobile communication systems in the future.

The network device 101 in the embodiments of the present disclosure may be a core network device, such as a user port function (UPF), a session management function (SMF), a policy control function (PCF), etc. The network device 101 may also be an entity on the network side for sending or receiving signals. For example, the network device 101 may be an evolved NodeB (eNB), a transmission reception point (TRP), a next generation NodeB (gNB) in an NR system, a base station in other mobile communication system in the future, or an access point in a wireless fidelity (WiFi) system. The embodiments of the present disclosure do not limit the specific technology and the specific device form used by the network device.

The terminal 102 in the embodiments of the present disclosure is an entity on the user side for receiving or sending signals, such as a mobile phone. Terminal may also be called, a terminal device, a user equipment (UE), a mobile station (MS), a mobile terminal (MT), etc. Terminal may be a car with communication function, a smart car, a mobile phone, a wearable device, a Pad, a computer with a wireless receiving and sending function, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. The embodiments of the present disclosure do not limit the specific technology and the specific device form used by the terminal.

The first network device mentioned in the embodiments of the present application may be a core network device in the at least one network device 101, such as a policy control function (PCF) and a session management function (SMF). The terminal mentioned in the embodiments of the present application may be any one of the at least one terminal 102.

It should be understood that the communication system in the embodiments of the present disclosure is to more clearly illustrate the technical solution of the embodiments of the present disclosure, and does not constitute a limitation on the technical solution in the embodiments of the present disclosure. Those skilled in the art may know, with the evolution of the system architecture and the emergence of new service scenarios, the technical solution in the embodiments of the present disclosure is also applicable to similar technical problems.

The control method and apparatus provided by the present application will be described in detail in conjunction with the accompanying drawings.

Please refer to FIG. 2, which is a flowchart of a control method provided by an embodiment of the present disclosure. As shown in FIG. 2, the method may be performed by a UE, and include but not limited to the following steps.

At step 201, an assistance operation rule sent by a first network device to the UE is received.

As a possible implementation of the embodiment, the assistance operation rule sent by the first network device to the UE in a direct manner is received. In the case where a direct communication interface exists between the first network device and the UE, the first network device may send the assistance operation rule to the UE in a direct manner.

As another possible implementation of the embodiment, the assistance operation rule sent by the first network device to the UE indirectly through at least one second network device is received. In the case where there is no direct communication interface between the first network device and the UE, the first network device may send the assistance operation rule to the UE indirectly through at least one second network device.

It should be noted that the sending mentioned in the embodiments of the present disclosure covers direct sending and indirect sending, but is not limited to the direct sending. Those skilled in the art may understand that the direct sending and the indirect sending may be flexibly selected based on whether there is a direct communication interface between a sender and a receiver.

In an embodiment of the present application, the assistance operation rule includes at least one of the following information:
a UE status assistance operation mode;
a UE status assistance operation mode indication;
a threshold;
a UE status assistance operation function;
a priority; or
an importance.

In order to clearly explain the aforementioned information contained in the assistance operation rule, the meaning of the aforementioned information is explained in a table form in this embodiment. Table 1 is a list of the information contained in the assistance operation rule.

TABLE 1
list of information contained in the assistance operation rule

| Information name | Description | Category |
|---|---|---|
| UE status assistance | identifying a data flow and/or parameter for | Mandatory |
| operation mode | which the first network device performs quality | |
| | of service (QoS) control based on assistance | |
| | of the UE | |
| UE status assistance | identifying an operation mode of at least one | Mandatory |
| operation mode | QoS control performed by the first network | |
| indication | device based on assistance of the UE; the | |
| | operation mode including at least one of: load | |
| | balancing; power consumption balancing; packet | |
| | data unit (PDU) set based QoS handling; slicing | |
| | reselection; or extended reality and multimedia | |
| | (XRM) coordination | |
| threshold | identifying an indicator threshold for the first | Optional |
| | network device to perform the QoS control; | |
| | the threshold including at least one of: a | |
| | maximum round trip time (RTT); a maximum packet | |
| | loss rate; a guaranteed traffic bit rate (GFBR) | |
| | threshold; or an aggregate maximum bit rate | |
| | (AMBR) threshold | |
| UE status assistance | identifying whether an operation mode of at least | Optional |
| operation function | one QoS control performed by the first network | |
| | device based on assistance of the UE is applied | |
| | to a data flow matching the UE status assistance | |
| | operation mode | |
| priority/importance | identifying whether a data flow for which the | Optional |
| | first network device performs the QoS control needs | |
| | to comply with a preset priority and/or a preset | |
| | importance level | |

The first column in the table is the information name. The second column is the specific description of information corresponding to the information name in the corresponding row, to explain its connotation. The third column in the table is the category, which is classified into mandatory and optional. Mandatory indicates that the information in the corresponding row is recommended to be added to the assistance operation rule, and optional indicates that the information in the corresponding row may be added to the assistance operation rule according to needs.

It is understandable that each element in Table 1 exists independently. These elements are listed in the same table for example, but it does not mean that all elements in the table must exist in the table as shown at the same time. The value of each element is independent of the value of any other element in Table 1. Therefore, those skilled in the art may understand that each element in Table 1 is an independent embodiment. For example, each row in Table 1 does not need to exist in assistance operation information at the same time, and the information corresponding to each row may be combined to obtain different embodiments, so as to flexibly adapt to different scenarios and needs.

At step 202, assistance operation information is sent to the first network device according to status information of the UE and the assistance operation rule.

As a possible implementation of the embodiment, the status information may be an operating status related to hardware of the UE. Optionally, the status information includes at least one of: device temperature information; device overheating information; battery life information; power supply mode information; remaining battery level information; remaining available battery time information; or central processing unit (CPU) load information.

The power supply mode information is used to indicate whether the UE is in at least one of the following situations: the UE being powered in a power saving mode; the UE being powered by an external battery; the UE being powered by an internal battery; the UE being powered by mains power/wall power.

It should be noted that, as another possible implementation, the status information may also be an operating status of a service performed by the UE, such as service operation lagging, display abnormality, etc.

As a possible implementation of the embodiment, the assistance operation information is used for the first network device to make a policy decision or perform the QoS control on an uplink of the UE; and/or the assistance operation information is used for the first network device to make a policy decision or perform the QoS control on a downlink of the UE.

The uplink and downlink may be used for the following transmissions: data streams, data packets, data packet sets (PDU sets), QoS flows, PDU sessions, UE slices, XRM service groups and other different granularities. Those skilled in the art may understand that applying the uplink and downlink to the above-mentioned different transmission scenarios does not affect the implementation of the embodiments of the present disclosure. Therefore, the transmission granularity is not limited in the embodiments of the present disclosure.

Since the assistance operation information is generated by the UE based on its own status information and under a limitation of the assistance operation rule sent by the first network device, the assistance operation information is generated by the UE in balancing states of the network side and the UE side. The first network device may perform a policy update of a PCC rule and/or QoS rule based on the assistance operation information, so that the updated rule or QoS matches the state of the UE.

As a possible implementation of the embodiment, the assistance operation information includes: a decision and/or a requirement generated by the UE based on the status information and the assistance operation rule. In some scenarios, the UE may only generate a QoS-related adjustment requirement based on the status information and the assistance operation rule, and the first network device makes a decision based on the requirement, and then updates the PCC rule and/or QoS rule based on the decision. In other scenarios, the UE may generate a decision based on the status information and the assistance operation rule, and the first network device updates the PCC rule and/or QoS rule based on the decision of the UE.

Based on this, optionally, the assistance operation information may further include the status information of the UE. By including the status information of the UE in the assistance operation information, the first network device may learn, based on the status information of the UE, why the UE makes the aforementioned decision and/or requirement, which is conducive to the service guarantee of the UE when performing the policy update of the PCC rule and/or QoS rule.

In this embodiment, the assistance operation rule is sent to the UE by the first network device, so that after the UE receives the assistance operation rule sent by the first network device, the UE sends the assistance operation information to the first network device based on the status information of the UE and the assistance operation rule, and the first network device makes the policy decision or performs the QoS control based on the assistance operation information. Since the assistance operation rule sent by the UE is generated based on the status information of the UE, the UE may assist the first network device in making the policy decision or performing the QoS control based on its own status information, which is conducive to the service guarantee of the UE.

Please refer to FIG. 3, which is a flowchart of a control method provided by an embodiment of the present disclosure. As shown in FIG. 3, the method may be performed by a UE, and include but not limited to the following steps.

At step 301, an assistance operation rule sent by a first network device to the UE is received.

Regarding the step 301 in the embodiment, reference may be made to related description of the step 201 in the foregoing embodiment, which is not repeated in the embodiment.

At step 302, it is determined, according to status information of the UE, whether to assist in making a policy decision or performing a QoS control.

The UE may assist the network side in making the policy decision or performing the QoS control based on its own state; or the UE may determine, based on its own state, that the policy decision is made or the QoS control may be performed only based on the network side, that is, determining not to provide assistance.

In a possible scenario, the UE has energy anomalies or hardware resource anomalies, that is, based on the device temperature information, the device overheating information, the battery life information, the power supply mode information, the remaining battery level information, the remaining available battery time information and the CPU load information in the status information, it is determined that the UE needs to appropriately reduce energy consumption. Based on this, the UE may choose to assist the network side in making the policy decision or performing the QoS control. Through the policy decision or the QoS control of the network side, at least one method including load balancing, power consumption balancing, PDU set based QoS handling, slicing reselection or XRM coordination is adopted to reduce the energy consumption of the UE and extend usage time of the UE.

At step 303, in a case of determining to assist in making the policy decision or performing the QoS control, assistance operation information is sent to the first network device according to status information of the UE and the assistance operation rule.

Regarding the manner in which the UE sends the assistance operation information to the first network device according to the assistance operation rule and its own status information, reference may be made to relevant description of the step 202 in the aforementioned embodiment, which will not be repeated in the embodiment.

As a possible implementation of the embodiment, in the case where the UE determines that there is no need to assist in making the policy decision or performing the QoS control at present, the UE monitors the subsequent status information of the UE. When it is monitored that the status information of the UE changes or when a preset condition is met, the step 302 is executed again until it is determined that there is a need to assist in making the policy decision or performing the QoS control, and the step 303 is executed.

In this embodiment, the assistance operation rule is sent to the UE by the first network device, so that after the UE receives the assistance operation rule sent by the first network device, the UE sends the assistance operation information to the first network device based on the status information of the UE and the assistance operation rule, and the first network device makes the policy decision or performs the QoS control based on the assistance operation information. Since the assistance operation rule sent by the UE is generated based on the status information of the UE, the UE may assist the first network device in making the policy decision or performing the QoS control based on its own status information, which is conducive to the service guarantee of the UE.

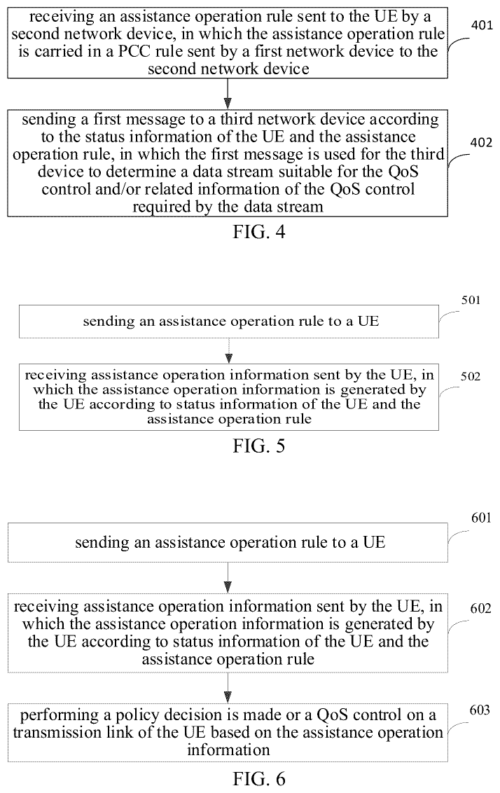

Please refer to FIG. 4, which is a flowchart of a control method provided by an embodiment of the present disclosure. As shown in FIG. 4, the method may be performed by a UE, and include but not limited to the following steps.

At step 401, an assistance operation rule sent to the UE is received by a second network device. The assistance operation rule is carried in a PCC rule sent by a first network device to the second network device.

In order to clearly explain the information contained in the PCC rule, the meaning of the aforementioned information is explained in a table form in this embodiment. Table 2 is a list of the information contained in the PCC rule.

TABLE 2
list of information contained in the PCC rule

| Information name | Description | Category |
|---|---|---|
| rule identifier | unique identifier to identify the rule | Mandatory |
| rule precedence | determining an order in which the rule is evaluated | Mandatory |
| data flow descriptor | defining a data flow suitable for the rule | Mandatory |
| application descriptor | identifying information of an application for | Optional |
| | generating a data flow | |
| IP descriptor | identifying at least one five-tuple information of | Optional |
| | an IP data flow | |
| non-IP descriptor | identifying at least one kind of information of a | Optional |
| | non-IP data flow | |
| UE status assistance | identifying a data flow and/or parameter for which | Mandatory |
| operation mode | the first network device performs QoS control based | |
| | on assistance of the UE | |
| UE status assistance | identifying an operation mode of at least one QoS | Mandatory |
| operation mode | control performed by the first network device based | |
| indication | on assistance of the UE; the operation mode including | |
| | at least one of: load balancing; power consumption | |
| | balancing; packet data unit (PDU) set based QoS | |
| | handling; slicing reselection; or extended reality | |
| | and multimedia (XRM) coordination | |
| threshold | identifying an indicator threshold for the first | Optional |
| | network device to perform the QoS control; the | |
| | threshold including at least one of: a maximum RTT; | |
| | a maximum packet loss rate; a GFBR threshold; or | |
| | an AMBR threshold | |
| UE status assistance | identifying whether an operation mode of at least | Optional |
| operation function | one QoS control performed by the first network device | |
| | based on assistance of the UE is applied to a data | |
| | flow matching the UE status assistance operation mode | |
| priority/importance | identifying whether a data flow for which the first | Optional |
| | network device performs the QoS control needs to | |
| | comply with a preset priority and/or a preset | |
| | importance level | |

The first column in the table is the information name. The second column is the specific description of information corresponding to the information name in the corresponding row, to explain its connotation. The third column in the table is the category, which is classified into mandatory and optional. Mandatory indicates that the information in the corresponding row is recommended to be added to the PCC rule, and optional indicates that the information in the corresponding row may be added to the PCC rule according to needs.

It is understandable that each element in Table 2 exists independently. These elements are listed in the same table for example, but it does not mean that all elements in the table must exist in the table as shown at the same time. The value of each element is independent of the value of any other element in Table 2. Therefore, those skilled in the art may understand that each element in Table 2 is an independent embodiment. For example, each row in Table 2 does not need to exist in assistance operation information at the same time, and the information corresponding to each row may be combined to obtain different embodiments, so as to flexibly adapt to different scenarios and needs.

In the related art, in a process that the UE requests to establish a PDU session, the first network device generates a corresponding PCC rule and sends it to the second network device, so that the second network device may generate a corresponding QoS rule for transmission of the uplink/downlink of the UE according to the PCC rule. The second network device sends the QoS rule to a third network device, such as UPF, (R)AN, etc. for execution. In this embodiment, the first network device carries the assistance operation rule in the PCC rule, sends the assistance operation rule to the second network device, so that the second network device sends the QoS rule generated based on the PCC rule to the third network device for execution and sends the assistance operation rule to the UE, and the UE generates the assistance operation information and sends it to the first network device. The assistance operation information is used for the first network device to make the policy decision or perform the QoS control on the uplink/downlink of the UE.

At step 402, a first message is sent to a third network device based on status information of the UE and the assistance operation rule. The first message is used for the third device to determine a data stream suitable for the QoS control and/or related information of the QoS control required by the data stream.

As a possible implementation, the UE selects the data streams and/or the related information such as a QoS control parameter from a range authorized by the assistance operation rule according to its own status information. The selected data stream and/or QoS control parameter may be carried in the first message and sent to the third network device, such as UPF, (Radio) Access Network ((R)AN), etc., so that the third network device may determine the data stream suitable for the QoS control and/or the related information of the QoS control required by the data stream based on the first message. After receiving the QoS rule obtained by the first network device for making the policy decision or performing the QoS control on the uplink/downlink of the UE based on the assistance operation information, the third network device applies the QoS rule to the data stream indicated in the first message and/or the related information of the QoS control required by the data stream.

It should be noted that the first message mentioned in this embodiment may be called a performance measurement function-UE status assistance data (PMF-UAD) message. Those skilled in the art may know that the first message may also be other messages, which is not limited in the embodiments of the present disclosure.

At step 403, a second message is sent to the third network device according to the status information of the UE and the assistance operation rule. The second message is used to notify the third device to stop performing the QoS control assisted by the UE.

As a possible implementation, the UE determines that it is not necessary to assist the network side in performing the QoS control based on its own status information, and then sends the second message to the third network device. For example, if the UE is in a state of power boosting or the UE is powered by mains/wall power, in order to improve the power supply of the UE, and there is no need to reduce energy consumption, the second message may be sent to the third network device to notify the third device to stop performing the QoS control assisted by the UE.

It should be noted that the second message mentioned in this embodiment may be called a performance measurement function-UE status assistance termination (PMF-UAT) message. Those skilled in the art may know that the first message may also be other messages, which is not limited in the embodiments of the present disclosure.

In this embodiment, the assistance operation rule is sent to the UE by the first network device, so that after the UE receives the assistance operation rule sent by the first network device, the UE sends the assistance operation information to the first network device based on the status information of the UE and the assistance operation rule, and the first network device makes the policy decision or performs the QoS control based on the assistance operation information. Since the assistance operation rule sent by the UE is generated based on the status information of the UE, the UE may assist the first network device in making the policy decision or performing the QoS control based on its own status information, which is conducive to the service guarantee of the UE.

Please refer to FIG. 5, which is a flowchart of a control method provided by an embodiment of the present disclosure. As shown in FIG. 5, the method may be performed by a first network device, and include but not limited to the following steps.

At step 501, an assistance operation rule is sent to a UE.

As a possible implementation of the embodiment, the first network device sends the assistance operation rule to the UE in a direct manner. In the case where a direct communication interface exists between the first network device and the UE, the first network device may send the assistance operation rule to the UE in a direct manner.

As another possible implementation of the embodiment, the first network device sends the assistance operation rule to the UE indirectly through at least one second network device. In the case where there is no direct communication interface between the first network device and the UE, the first network device may send the assistance operation rule to the UE indirectly through at least one second network device.

It should be noted that the sending mentioned in the embodiments of the present disclosure covers direct sending and indirect sending, but is not limited to the direct sending. Those skilled in the art may understand that the direct sending and the indirect sending may be flexibly selected based on whether there is a direct communication interface between a sender and a receiver.

In an embodiment of the present application, the assistance operation rule includes at least one of the following information:
a UE status assistance operation mode;
a UE status assistance operation mode indication;
a threshold;
a UE status assistance operation function;
a priority; or
an importance.

In order to clearly explain the aforementioned information contained in the assistance operation rule, reference may be made to relevant description of the foregoing Table 1, which is not repeated in the embodiments of the present disclosure.

In the related art, in a process that the UE requests to establish a PDU session, the first network device generates a corresponding PCC rule and sends it to the second network device, so that the second network device may generate a corresponding QoS rule for transmission of the uplink/downlink of the UE according to the PCC rule. The second network device sends the QoS rule to a third network device, such as UPF, (R)AN, etc. for execution.

In this embodiment, as a possible implementation, the first network device carries the assistance operation rule in the PCC rule, as shown in Table 2. The first network device sends the assistance operation rule to the second network device by carrying it in the PCC rule, so that the second network device sends the QoS rule generated based on the PCC rule to the third network device for execution and sends the assistance operation rule to the UE, and the UE generates the assistance operation information and sends it to the first network device. The assistance operation information is used for the first network device to make the policy decision or perform the QoS control on the uplink/downlink of the UE.

At step 502, assistance operation information sent by the UE is received. The assistance operation information is generated by the UE according to status information of the UE and the assistance operation rule.

As a possible implementation of the embodiment, the status information may be an operating status related to hardware of the UE. Optionally, the status information includes at least one of: device temperature information; device overheating information; battery life information; power supply mode information; remaining battery level information; remaining available battery time information; or CPU load information.

The power supply mode information is used to indicate whether the UE is in at least one of the following situations: the UE being powered in a power saving mode; the UE being powered by an external battery; the UE being powered by an internal battery; the UE being powered by mains power/wall power.

It should be noted that, as another possible implementation, the status information may also be an operating status of a service performed by the UE, such as service operation lagging, display abnormality, etc.

As a possible implementation of the embodiment, the assistance operation information is used for making a policy decision or performing the QoS control on an uplink of the UE; and/or the assistance operation information is used for making a policy decision or performing the QoS control on a downlink of the UE. The network element for making the policy decision or performing the QoS control may be the first network device in the embodiments or other network devices, which is not limited in the embodiments of the present disclosure.

The uplink and downlink may be used for the following transmissions: data streams, data packets, data packet sets (PDU sets), QoS flows, PDU sessions, UE slices, XRM service groups and other different granularities. Those skilled in the art may understand that applying the uplink and downlink to the above-mentioned different transmission scenarios does not affect the implementation of the embodiments of the present disclosure. Therefore, the transmission granularity is not limited in the embodiments of the present disclosure.

Since the assistance operation information is generated by the UE based on its own status information and under a limitation of the assistance operation rule sent by the first network device, the assistance operation information is generated by the UE in balancing states of the network side and the UE side. The associated network device may perform a policy update of a PCC rule and/or QoS rule based on the assistance operation information, so that the updated rule or QoS matches the state of the UE.

As a possible implementation of the embodiment, the assistance operation information includes: a decision and/or a requirement generated by the UE based on the status information and the assistance operation rule. In some scenarios, the UE may only generate a QoS-related adjustment requirement based on the status information and the assistance operation rule, and the associated network device makes a decision based on the requirement, and then updates the PCC rule and/or QoS rule based on the decision. In other scenarios, the UE may generate a decision based on the status information and the assistance operation rule, and the associated network device updates the PCC rule and/or QoS rule based on the decision of the UE.

Based on this, optionally, the assistance operation information may further include the status information of the UE. By including the status information of the UE in the assistance operation information, the associated network device may learn, based on the status information of the UE, why the UE makes the aforementioned decision and/or requirement, which is conducive to the service guarantee of the UE when performing the policy update of the PCC rule and/or QoS rule.

In this embodiment, the assistance operation rule is sent to the UE by the first network device, so that after the UE receives the assistance operation rule sent by the first network device, the UE sends the assistance operation information to the first network device based on the status information of the UE and the assistance operation rule, and the first network device makes the policy decision or performs the QoS control based on the assistance operation information. Since the assistance operation rule sent by the UE is generated based on the status information of the UE, the UE may assist in making the policy decision or performing the QoS control based on its own status information, which is conducive to the service guarantee of the UE.

Please refer to FIG. 6, which is a flowchart of a control method provided by an embodiment of the present disclosure. As shown in FIG. 6, the method may be performed by a first network device, and include but not limited to the following steps.

At step 601, an assistance operation rule is sent to a UE.

At step 602, assistance operation information sent by the UE is received. The assistance operation information is generated by the UE according to status information of the UE and the assistance operation rule.

Regarding the steps 601-602 in the embodiment, reference may be made to related description of the steps 501-502 in the foregoing embodiment, which is not repeated in the embodiment.

At step 603, a policy decision is made or a QoS control is performed on a transmission link of the UE based on the assistance operation information.

The transmission link includes an uplink and/or a downlink.

The uplink and downlink may be used for the following transmissions: data streams, data packets, data packet sets (PDU sets), QoS flows, PDU sessions, UE slices, UE, XRM service groups and other different granularities. Those skilled in the art may understand that applying the uplink and downlink to the above-mentioned different transmission scenarios does not affect the implementation of the embodiments of the present disclosure. Therefore, the embodiments of the present disclosure do not limit thereto.

In a possible scenario, the UE has energy anomalies or hardware resource anomalies, that is, based on the device temperature information, the device overheating information, the battery life information, the power supply mode information, the remaining battery level information, the remaining available battery time information and the CPU load information in the status information, it is determined that the UE needs to appropriately reduce energy consumption. Based on this, the UE may choose to assist the network side in making the policy decision or performing the QoS control, and send the assistance operation information to the first network device, so that the first network device adopts at least one method including load balancing, power consumption balancing, PDU set based QoS handling, slicing reselection or XRM coordination to reduce the energy consumption of the UE and extend usage time of the UE.

In this embodiment, the assistance operation rule is sent to the UE by the first network device, so that after the UE receives the assistance operation rule sent by the first network device, the UE sends the assistance operation information to the first network device based on the status information of the UE and the assistance operation rule, and the first network device makes the policy decision or performs the QoS control based on the assistance operation information. Since the assistance operation rule sent by the UE is generated based on the status information of the UE, the UE may assist the first network device in making the policy decision or performing the QoS control based on its own status information, which is conducive to the service guarantee of the UE.

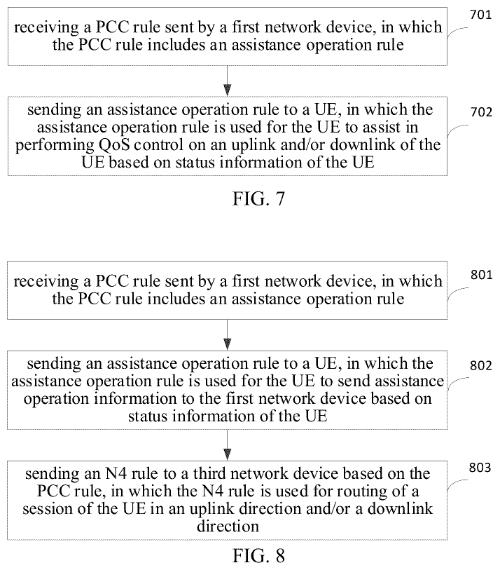

Please refer to FIG. 7, which is a flowchart of a control method provided by an embodiment of the present disclosure. As shown in FIG. 7, the method may be performed by a second network device, and include but not limited to the following steps.

At step 701, a PCC rule sent by a first network device is received. The PCC rule includes an assistance operation rule.

As a possible implementation of the embodiment, the first network device carries the assistance operation rule in the PCC rule, as shown in Table 2. Regarding the information contained in the PCC rule, reference may be made to related description of Table 2, which is not repeated in the embodiments of the present disclosure.

At step 702, an assistance operation rule is sent to a UE. The assistance operation rule is used for the UE to assist in performing QoS control on an uplink and/or downlink of the UE based on status information of the UE.

As a possible implementation of the embodiment, the assistance operation rule is used for the UE to send assistance operation information to the first network device according to the status information of the UE. The first network device carries the assistance operation rule in the PCC rule and sends it to the second network device, so that the second network device sends a QoS rule generated based on the PCC rule to the third network device for execution and sends the assistance operation rule in the PCC rule to the UE, and the UE generates the assistance operation information accordingly and sends it to the first network device. The assistance operation information may be used for making a policy decision or performing the QoS control on the uplink/downlink of the UE.

As another possible implementation of the embodiment, the assistance operation rule is used for the UE to perform QoS adjustment by itself according to the status information of the UE and the assistance operation rule. The first network device carries the assistance operation rule in the PCC rule and sends it to the second network device, so that the second network device sends a QoS rule generated based on the PCC rule to the third network device for execution and sends the assistance operation rule in the PCC rule to the UE, and the UE performs QoS adjustment by itself based on the status information of the UE and the assistance operation rule. In some embodiments, the UE selects QoS related parameters by itself from a range authorized by the assistance operation rule according to the status information of the UE. For example, in the case of abnormal energy consumption of the UE, the energy consumption abnormality may be improved by adjusting the QoS-related parameters such as delay, packet loss rate, and bandwidth.

In this embodiment, the assistance operation rule is sent to the UE by the first network device, so that after the UE receives the assistance operation rule sent by the first network device, the UE sends the assistance operation information to the first network device based on the status information of the UE and the assistance operation rule, and the first network device makes the policy decision or performs the QoS control based on the assistance operation information, or the UE performs the QoS adjustment by itself based on the assistance operation rule and the status information of the UE. Since the assistance operation rule sent by the UE is generated based on the status information of the UE, the UE may assist the first network device in making the policy decision or performing the QoS control based on its own status information, which is conducive to the service guarantee of the UE.

Please refer to FIG. 8, which is a flowchart of a control method provided by an embodiment of the present disclosure. As shown in FIG. 8, the method may be performed by a second network device, and include but not limited to the following steps.

At step 801, a PCC rule sent by a first network device is received. The PCC rule includes an assistance operation rule.

As a possible implementation of the embodiment, the first network device carries the assistance operation rule in the PCC rule, as shown in Table 2. Regarding the information contained in the PCC rule, reference may be made to related description of Table 2, which is not repeated in the embodiments of the present disclosure.

At step 802, an assistance operation rule is sent to a UE. The assistance operation rule is used for the UE to send assistance operation information to the first network device based on status information of the UE.

As a possible implementation of the embodiment, the second network device sends the assistance operation rule in the PCC rule to the UE, so that the UE generates the assistance operation information and sends it to the first network device. The assistance operation information may be used by the first network device to make a policy decision or perform QoS control on an uplink/downlink of the UE.

At step 803, an N4 rule is sent to a third network device based on the PCC rule. The N4 rule is used for routing of a session of the UE in an uplink direction and/or a downlink direction.

As a possible implementation of the embodiment, the first network device carries the assistance operation rule in the PCC rule and sends it to the second network device, so that the second network device sends a QoS rule generated based on the PCC rule to the third network device through an N4 interface between the second network device and the third network device for execution, and the third network device performs routing of the session of the UE in the uplink direction and/or the downlink direction. Since the above information is sent between the second network device and the third network device through the N4 interface, the rule sent by the second network device to the third network device may be called the N4 rule.

In this embodiment, the assistance operation rule is sent to the UE by the first network device, so that after the UE receives the assistance operation rule sent by the first network device, the UE sends the assistance operation information to the first network device based on the status information of the UE and the assistance operation rule, and the first network device makes the policy decision or performs the QoS control based on the assistance operation information. Since the assistance operation rule sent by the UE is generated based on the status information of the UE, the UE may assist the first network device in making the policy decision or performing the QoS control based on its own status information, which is conducive to the service guarantee of the UE.

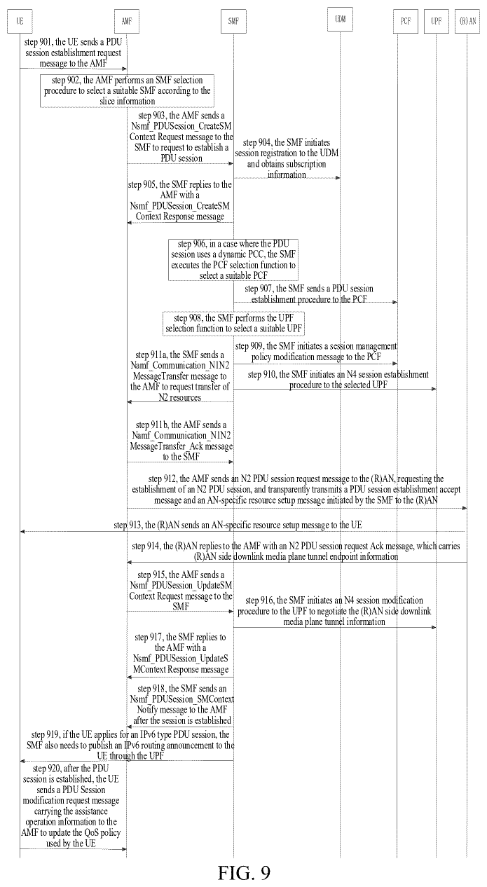

Please refer to FIG. 9, which is a schematic diagram illustrating an interaction process of a control method provided by an embodiment of the present disclosure. As shown in FIG. 9, a communication system for the interaction process may include a UE, a (R)AN, an access and mobility management function (AMF), a UPF, an SMF, a PCF, a unified data management (UDM) and a data network (DN).

At step 901, the UE sends a PDU session establishment request message to the AMF.

As a possible implementation, the PDU session establishment request message includes: single network slice selection assistance information (S-NSSAI) or S-NSSAI(s), data network name (DNN), PDU session identifier, request type and other information.

At step 902, the AMF performs an SMF selection procedure to select a suitable SMF according to the slice information.

As a possible implementation, when the AMF receives the PDU session establishment request message from the UE and finds that a new PDU session is to be created, the AMF performs the SMF selection procedure to select the SMF for the PDU session.

At step 903, the AMF sends a PDU session creation context acquisition request (Nsmf_PDUSession_CreateSMContext Request) message to the SMF to request to establish a PDU session.

At step 904, the SMF initiates session registration to the UDM and obtains subscription information.

At step 905, the SMF replies to the AMF with a PDU session creation context acquisition response (Nsmf_PDUSession_CreateSMContext Response) message.

The Nsmf_PDUSession_CreateSMContext Response message carries different parameters depending on whether the session is successfully established.

Furthermore, if the session establishment procedure is successfully performed and a session management (SM) context is created, the SM context identifier is brought to the AMF in the Nsmf_PDUSession_CreateSMContext Response message. If the session establishment procedure fails, the AMF is notified of the session procedure failure through a message, and the AMF releases session-related resources and sends a PDU session reject message to the UE.

At step 906, in a case where the PDU session uses a dynamic PCC, the SMF executes the PCF selection function to select a suitable PCF.

When the PDU session requests support for XR service/multimodal service, the SMF and the PCF generate/activate a PCC rule for enhancing the data flow supporting the XR service and multimodal session based on the application information.

It should be noted that, when the PDU session does not use the dynamic PCC, the SMF executes a local policy.

At step 907, the SMF sends a PDU session establishment procedure to the PCF.

Based on the PDU session establishment procedure, the PCF may send the following information to the SMF: PCC rule, charging control policy, UPF selection policy, etc. The PCC rule includes a QoS rule and an assistance operation rule.

At step 908, the SMF performs the UPF selection function to select a suitable UPF.

As a possible implementation, the SMF selects the UPF based on the data network name (DNN), user location information, etc.

At step 909, the SMF initiates a session management policy modification message to the PCF.

As a possible implementation, the session management policy modification message carries information on the selected UPF, an IP address allocated to the UE, and a control and charging policy required to obtain the UPF.

At step 910, the SMF initiates an N4 session establishment procedure to the selected UPF.

Based on the establishment procedure, multiple rules are carried to the UPF, including packet detection rule (PDR), usage reporting rule (URR), forwarding action rule (FAR), buffering action rule (BAR), QoS enforcement rule (QER). Optionally, the assistance operation rule in the aforementioned PCC rule may also be included.

At step 911a, the SMF sends a Namf_Communication_N1N2MessageTransfer message to the AMF to request transfer of N2 resources.

As a possible implementation, the message carries an N1 Container and an N2 Container. The N1 Container is a PDU session establishment response that the SMF replies to UE, and the N2 Container is a resource establishment request initiated by the SMF to the (R)AN. The Namf_Communication_N1N2MessageTransfer message sent by the SMF to the AMF may carry the assistance operation rule.

At step 911b, the AMF sends a Namf_Communication_N1N2 message transfer response (Namf_Communication_N1N2MessageTransfer_Ack) message to the SMF.

At step 912, the AMF sends an N2 PDU session request message to the (R)AN, requesting the establishment of an N2 PDU session, and transparently transmits a PDU session establishment accept message and an AN-specific resource setup message initiated by the SMF to the (R)AN.

As a possible implementation, the PDU session establishment accept message carries the assistance operation rule.

At step 913, the (R)AN sends an AN-specific resource setup message to the UE.

A resource connection is established between the (R)AN and the UE according to the AN-specific resource setup message.

As a possible implementation, the AN-specific resource setup message carries the assistance operation rule and UPF media plane tunnel endpoint information.

At step 914, the (R)AN replies to the AMF with an N2 PDU session request Ack message, which carries (R)AN side downlink media plane tunnel endpoint information.

At step 915, the AMF sends a PDU session update session management context request (Nsmf_PDUSession_UpdateSMContext Request) message to the SMF.

The N2 Container is carried, the Container is a resource establishment response from the (R)AN to the SMF, which contains the (R)AN side media plane tunnel endpoint information.

At step 916, the SMF initiates an N4 session modification procedure to the UPF to negotiate the (R)AN side downlink media plane tunnel information.

At step 917, the SMF replies to the AMF with a PDU session update session management context request (Nsmf_PDUSession_UpdateSMContext Response) message.

At step 918, the SMF sends a PDU session context t notification (Nsmf_PDUSession_SMContextNotify) message to the AMF after the session is established.

At step 919, if the UE applies for an IPv6 type PDU session, the SMF also needs to publish an IPv6 routing announcement to the UE through the UPF.

At step 920, after the PDU session is established, the UE sends a PDU Session modification request message carrying the assistance operation information to the AMF to update the QoS policy used by the UE.

It should be noted that, in a possible implementation, in the aforementioned embodiments, the first network device mentioned may be the PCF in this embodiment, the second network device may be the SMF in this embodiment, the third network device may be the UPF in this embodiment, and the UE may be the UE in this embodiment.

In this embodiment, the assistance operation rule is sent to the UE by the PCF, so that after the UE receives the assistance operation rule sent by the PCF, the UE sends the assistance operation information to the PCF based on the status information of the UE and the assistance operation rule, and the PCF makes the policy decision or performs the QoS control based on the assistance operation information, to update the QoS policy used by the UE. Since the assistance operation rule sent by the UE is generated based on the status information of the UE, the UE may assist the PCF in making the policy decision or performing the QoS control based on its own status information, which is conducive to the service guarantee of the UE.

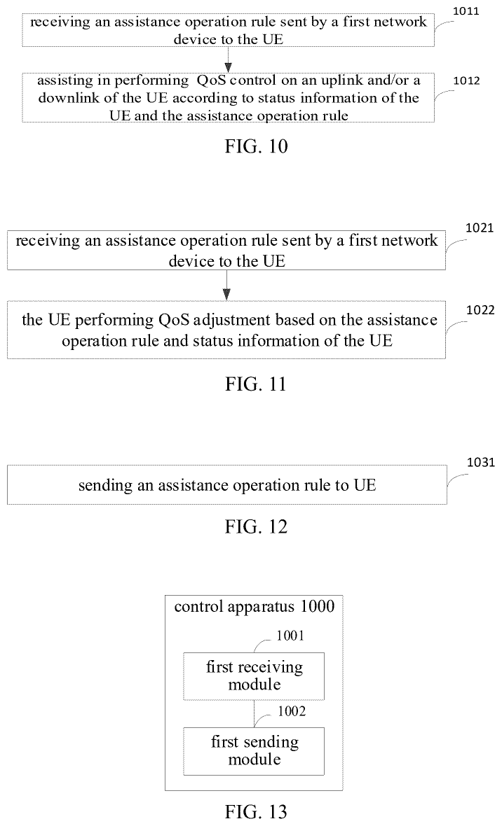

Please refer to FIG. 10, which is a flowchart of a control method provided by an embodiment of the present disclosure. As shown in FIG. 10, the method may be performed by a UE, and include but not limited to the following steps.

At step 1011, an assistance operation rule sent by a first network device to the UE is received.

In this embodiment, the first network device sends the assistance operation rule to the UE. For details, reference may be made to any of the above embodiments, which will not be described in detail in this embodiment.

At step 1012, QoS control on an uplink and/or a downlink of the UE is assisted according to status information of the UE and the assistance operation rule.

As a possible implementation, the UE performs QoS adjustment by itself based on the assistance operation rule and the status information of the UE. In some embodiments, the UE may select QoS-related parameters by itself based on the status information of the UE within a range authorized by the assistance operation rule. For example, if the UE has abnormal energy consumption, the QoS-related parameters such as delay, packet loss rate, and bandwidth may be adjusted to improve the abnormal energy consumption.

As another possible implementation, the UE sends the assistance operation information to the first network device based on the status information of the UE and the assistance operation rule. The UE sends the assistance operation information to the first network device based on the status information and the assistance operation rule, so that the first network device makes a policy decision or performs the QoS control based on the assistance operation information. Since the assistance operation rule sent by the UE is generated based on the status information of the UE, the UE may assist the first network device in making the policy decision or performing the QoS control based on its own status information, which is beneficial to the service guarantee of the UE. For the specific execution method of the UE sending the assistance operation information to the first network device based on the status information of the UE and the assistance operation rule, reference may be made to relevant description of any of the aforementioned embodiments, which will not be repeated in this embodiment.

In this embodiment, the assistance operation rule is sent to the UE by the first network device, so that after the UE receives the assistance operation rule sent by the first network device, the UE assists in performing the QoS control on the uplink and/or downlink of the UE based on the status information of the UE and the assistance operation rule. Since the QoS control is based on the status information of the UE and complies with the assistance operation rule sent by the first network device, the UE may assist the first network device in making the policy decision or performing the QoS control based on its own status information, which is conducive to the service guarantee of the UE.

Please refer to FIG. 11, which is a flowchart of a control method provided by an embodiment of the present disclosure. As shown in FIG. 11, the method may be performed by a UE, and include but not limited to the following steps.

At step 1021, an assistance operation rule sent by a first network device to the UE is received.

In this embodiment, the first network device sends the assistance operation rule to the UE. For details, reference may be made to any of the above embodiments, which will not be described in detail in this embodiment.

At step 1022, the UE performs QoS adjustment based on the assistance operation rule and status information of the UE.

In some embodiments, the UE may select QoS-related parameters based on the status information of the UE within a range authorized by the assistance operation rule.

For example, if the UE has abnormal energy consumption, the QoS-related parameters such as delay, packet loss rate, and bandwidth may be adjusted to improve the abnormal energy consumption.

For another example, when the power of the UE is low, the QoS-related parameters such as delay, packet loss rate, and bandwidth may be adjusted to improve the abnormal energy consumption. When the power of the UE is restored, the QoS related parameters such as delay, packet loss rate, and bandwidth before adjustment may be restored automatically, without waiting for an instruction of the associated network device, thus saving signaling overhead.

In this embodiment, the assistance operation rule is sent to the UE by the first network device, so that after the UE receives the assistance operation rule sent by the first network device, the UE may adjust the QoS by itself based on the status information of the UE and the assistance operation rule, without waiting for an instruction from the associated network device, thereby saving signaling overhead.

Please refer to FIG. 12, which is a flowchart of a control method provided by an embodiment of the present disclosure. As shown in FIG. 12, the method may be performed by a first network device, and include but not limited to the following steps.

At step 1031, an assistance operation rule is sent to a UE.

The assistance operation rule is used for the UE to assist in performing QoS control on an uplink and/or a downlink of the UE based on status information of the UE.

In this embodiment, for details of the first network device sending the assistance operation rule to the UE, reference may be made to any of the above embodiments, which will not be described in detail in this embodiment.

As a possible implementation, the assistance operation rule is used for the UE to perform QoS adjustment by itself based on and the status information of the UE and the assistance operation rule. In some embodiments, the UE may select QoS-related parameters by itself based on the status information of the UE within a range authorized by the assistance operation rule. For example, if the UE has abnormal energy consumption, the QoS-related parameters such as delay, packet loss rate, and bandwidth may be adjusted to improve the abnormal energy consumption.

As another possible implementation, the assistance operation rule is used for the UE to send assistance operation information to the first network device based on the status information of the UE and the assistance operation rule. The UE sends the assistance operation information to the first network device based on the status information and the assistance operation rule, so that the first network device makes a policy decision or performs the QoS control based on the assistance operation information. Since the assistance operation rule sent by the UE is generated based on the status information of the UE, the UE may assist the first network device in making the policy decision or performing the QoS control based on its own status information, which is beneficial to the service guarantee of the UE. For the specific execution method of the UE sending the assistance operation information to the first network device based on the status information of the UE and the assistance operation rule, reference may be made to relevant description of any of the aforementioned embodiments, which will not be repeated in this embodiment.

In this embodiment, the assistance operation rule is sent to the UE by the first network device, so that after the UE receives the assistance operation rule sent by the first network device, the UE assists in performing the QoS control on the uplink and/or downlink of the UE based on the status information of the UE and the assistance operation rule. Since the QoS control is based on the status information of the UE and complies with the assistance operation rule sent by the first network device, the UE may assist the first network device in making the policy decision or performing the QoS control based on its own status information, which is conducive to the service guarantee of the UE.

In the embodiments provided by the present disclosure, the methods provided by the embodiments of the present disclosure are introduced from the perspectives of the UE, the first network device, and the second network device. In order to implement the functions in the methods provided by the embodiments of the present disclosure, the UE, the first network device, and the second network device may include a hardware structure and a software module, and the functions are implemented in the form of the hardware structure, the software module, or the hardware structure plus the software module. A function of the functions may be executed in the form of the hardware structure, the software module, or the hardware structure plus the software module.

Please refer to FIG. 13, which is a block diagram of a control apparatus 1000 provided in an embodiment of the present disclosure. The control apparatus 1000 shown in FIG. 13 may be a terminal, an apparatus in the terminal, or an apparatus capable of being used in combination with the terminal. As shown in FIG. 13, the control apparatus 1000 may include a first receiving module 1001 and a first sending module 1002.

The first receiving module 1001 is configured to receive an assistance operation rule sent by a first network device to the UE.

The first sending module 1002 is configured to assist in performing quality of service (QoS) control on an uplink and/or a downlink of the UE according to status information of the UE and the assistance operation rule.

In an implementation, the UE performs QoS adjustment by itself based on the status information of the UE and the assistance operation rule.

In an implementation, assistance operation information is sent to the first network device according to the status information of the UE and the assistance operation rule.

In an implementation, the assistance operation information is used for the first network device to make a policy decision or perform the QoS control on an uplink data flow of the UE; and/or

the assistance operation information is used for the first network device to make a policy decision or perform the QoS control on a downlink data flow of the UE.

In an implementation, the assistance operation information includes: a decision and/or a requirement generated by the UE based on the status information and the assistance operation rule.

In an implementation, the assistance operation information further includes the status information of the UE.

In an implementation, the apparatus further includes:
a determining module, configured to determine whether to assist in making a policy decision or performing the QoS control according to the status information of the UE.

In an implementation, the receiving module is configured to:
receive the assistance operation rule sent to the UE by the first network device directly or indirectly through at least one second network device.

In an implementation, the apparatus further includes:
a second sending module, configured to send a first message to a third network device according to the status information of the UE and the assistance operation rule;
in which the first message is used for the third device to determine a data flow suitable for the QoS control and/or related information of the QoS control required by the data flow.

In an implementation, the apparatus further includes:
a third sending module, configured to send a second message to the third network device according to the status information of the UE and the assistance operation rule;
in which the second message is used to notify the third device to stop performing the QoS control assisted by the UE.

In an implementation, the status information includes at least one of:
device temperature information;
device overheating information;
battery life information;
power supply mode information;
remaining battery level information;
remaining available battery time information; or CPU load information.

In an implementation, the power supply mode information indicates whether the UE is in at least one of following situations:
the UE being powered in a power saving mode;
the UE being powered by an external battery;
the UE being powered by an internal battery; or
the UE being powered by mains/wall power.

In an implementation, the assistance operation rule includes at least one of:
a UE status assistance operation mode;
a UE status assistance operation mode indication;
a threshold;
a UE status assistance operation function;
a priority; or
an importance.

In an implementation, the UE status assistance operation mode indicates a data flow and/or a parameter for which the first network device performs the QoS control based on assistance of the UE.

In an implementation, the UE status assistance operation mode indication indicates an operation mode of at least one QoS control performed by the first network device based on assistance of the UE.

In an implementation, the operation mode includes at least one of:
load balancing;
power consumption balancing;
PDU set based QoS handling;
slicing reselection; or
XRM coordination.

In an implementation, the threshold indicates an indicator threshold for the first network device to perform the QoS control.

In an implementation, the threshold includes at least one of:
a maximum round trip time (RTT);
a maximum packet loss rate;
a guaranteed traffic bit rate (GFBR) threshold; or
an aggregate maximum bit rate (AMBR) threshold.

In an implementation, the UE status assistance operation function indicates whether an operation mode of at least one QoS control performed by the first network device based on assistance of the UE is applied to a data flow matching the UE status assistance operation mode.

In an implementation, the priority/importance indicates whether a data flow for which the first network device performs the QoS control needs to comply with a preset priority and/or a preset importance level.

It should be noted that the control apparatus provided in the embodiment of the present disclosure may implement all the method steps implemented by the control method embodiments shown in FIG. 2 to FIG. 4 above, and may achieve the same technical effects. The parts and beneficial effects of this embodiment that are the same as those of the method embodiments will not be described in detail here.

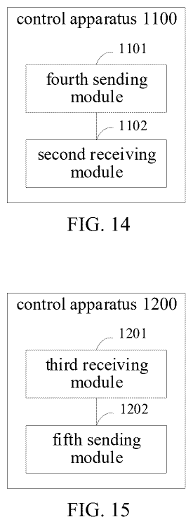

Please refer to FIG. 14, which is a block diagram of a control apparatus 1100 provided in an embodiment of the present disclosure. The control apparatus 1100 shown in FIG. 14 may be a network device (such as the first network device in the foregoing method embodiments), an apparatus in the network device, or an apparatus capable of being used in combination with the network device. As shown in FIG. 14, the control apparatus 1100 may include a fourth sending module 1101.

The fourth sending module 1101 is configured to send an assistance operation rule to a user equipment (UE), in which the assistance operation rule is used for the UE to assist in performing quality of service (QoS) control on an uplink and/or a downlink of the UE according to status information of the UE.

In an implementation, the control apparatus 1100 further includes a second receiving module 1102, configured to receive assistance operation information sent by the UE, in which the assistance operation information is generated by the UE according to the status information of the UE and the assistance operation rule.

In an implementation, the apparatus further includes:
a processing module, configured to make a policy decision or perform the QoS control on an uplink data flow of the UE based on the assistance operation information; and/or
make a policy decision or perform the QoS control on a downlink data flow of the UE based on the assistance operation information.

In an implementation, the assistance operation information includes: a decision and/or a requirement generated by the UE based on the status information and the assistance operation rule.

In an implementation, the assistance operation information further includes the status information of the UE.

In an implementation, the status information includes at least one of:
device temperature information;
device overheating information;
battery life information;
power supply mode information;
remaining battery level information;
remaining available battery time information; or
CPU load information.

In an implementation, the power supply mode information indicates whether the UE is in at least one of following situations:
the UE being powered in a power saving mode;
the UE being powered by an external battery;
the UE being powered by an internal battery; or
the UE being powered by mains/wall power.

In an implementation, the assistance operation rule is carried in a policy and charging control (PCC) rule.

In an implementation, the assistance operation rule includes at least one of:
a UE status assistance operation mode;
a UE status assistance operation mode indication;
a threshold;
a UE status assistance operation function;
a priority; or
an importance.

In an implementation, the UE status assistance operation mode indicates a data flow and/or a parameter for which the first network device performs the QoS control based on assistance of the UE.

In an implementation, the UE status assistance operation mode indication indicates an operation mode of at least one QoS control performed by the first network device based on assistance of the UE.

In an implementation, the operation mode includes at least one of:
load balancing;
power consumption balancing;
PDU set based QoS handling;
slicing reselection; or
XRM coordination.

In an implementation, the threshold indicates an indicator threshold for the first network device to perform the QoS control.

In an implementation, the threshold includes at least one of:
a maximum round trip time (RTT);
a maximum packet loss rate;
a guaranteed traffic bit rate (GFBR) threshold; or
an aggregate maximum bit rate (AMBR) threshold.

In an implementation, the UE status assistance operation function indicates whether an operation mode of at least one QoS control performed by the first network device based on assistance of the UE is applied to a data flow matching the UE status assistance operation mode.

In an implementation, the priority/importance indicates whether a data flow for which the first network device performs the QoS control needs to comply with a preset priority and/or a preset importance level.

It should be noted that the control apparatus provided in the embodiment of the present disclosure may implement all the method steps implemented by the control method embodiments shown in FIG. 5 to FIG. 6 above, and may achieve the same technical effects. The parts and beneficial effects of this embodiment that are the same as those of the method embodiments will not be described in detail here.

Please refer to FIG. 15, which is a block diagram of a control apparatus 1200 provided in an embodiment of the present disclosure. The control apparatus 1200 shown in FIG. 15 may be a network device (such as the second network device in the foregoing method embodiments), an apparatus in the network device, or an apparatus capable of being used in combination with the network device. As shown in FIG. 15, the control apparatus 1200 may include a third receiving module 1201 and a fifth sending module 1202.

The third receiving module 1201 is configured to receive a policy and charging control (PCC) rule sent by a first network device, in which the PCC rule includes an assistance operation rule.

The fifth sending module 1202 is configured to send the assistance operation rule to a user equipment (UE), in which the assistance operation rule is used for the UE to assist in performing quality of service (QoS) control on an uplink and/or a downlink of the UE according to status information of the UE.

In an implementation, the apparatus further includes:
a sixth sending module, configured to send an N4 rule to a third network device based on the PCC rule, in which the N4 rule is used for routing of a session of the UE in an uplink direction and/or a downlink direction.

It should be noted that the control apparatus provided in the embodiment of the present disclosure may implement all the method steps implemented by the control method embodiments shown in FIG. 7 to FIG. 8 above, and may achieve the same technical effects. The parts and beneficial effects of this embodiment that are the same as those of the method embodiments will not be described in detail here.

In order to implement the above-mentioned embodiments, the embodiments of the present disclosure also provide a communication apparatus, including: a processor and a memory, in which a computer program is stored in the memory; the processor executes the computer program stored in the memory to cause the communication apparatus to perform the method shown in the embodiments of FIG. 2 to FIG. 4 above.

In order to implement the above-mentioned embodiments, the embodiments of the present disclosure also provide a communication apparatus, including: a processor and a memory, in which a computer program is stored in the memory; the processor executes the computer program stored in the memory to cause the communication apparatus to perform the method shown in the embodiments of FIG. 5 to FIG. 6 above.

In order to implement the above-mentioned embodiments, the embodiments of the present disclosure also provide a communication apparatus, including: a processor and a memory, in which a computer program is stored in the memory; the processor executes the computer program stored in the memory to cause the communication apparatus to perform the method shown in the embodiments of FIG. 7 to FIG. 8 above.

In order to implement the above-mentioned embodiments, the embodiments of the present application also provide a communication apparatus, including: a processor and an interface circuit, in which the interface circuit is used to receive code instructions and transmit them to the processor, and the processor is used to run the code instructions to cause the apparatus to perform the method shown in the embodiments of FIG. 2 to FIG. 4 above.

In order to implement the above-mentioned embodiments, the embodiments of the present application also provide a communication apparatus, including: a processor and an interface circuit, in which the interface circuit is used to receive code instructions and transmit them to the processor, and the processor is used to run the code instructions to cause the apparatus to perform the method shown in the embodiments of FIG. 5 to FIG. 6 above.

In order to implement the above-mentioned embodiments, the embodiments of the present application also provide a communication apparatus, including: a processor and an interface circuit, in which the interface circuit is used to receive code instructions and transmit them to the processor, and the processor is used to run the code instructions to cause the apparatus to perform the method shown in the embodiments of FIG. 7 to FIG. 8 above.

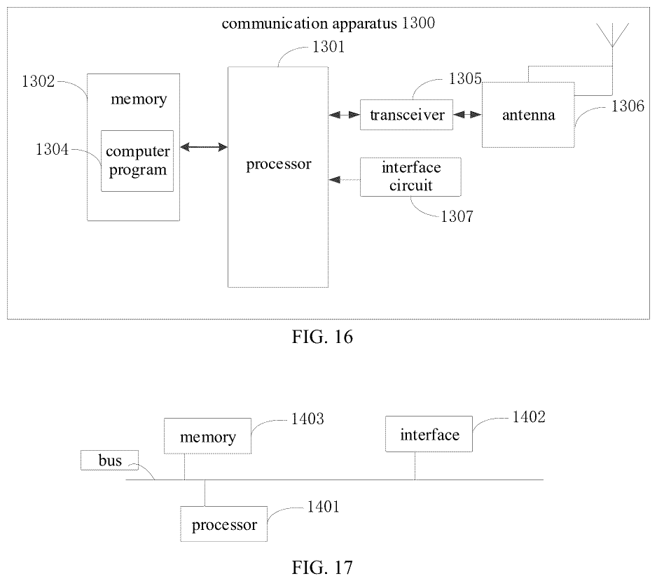

Please refer to FIG. 16, which is a schematic diagram of a communication apparatus 1300 provided in an embodiment of the present application. The communication apparatus 1300 can be a terminal, or a network device (such as the first network device and the second network device in the aforementioned method embodiments), or a chip, a chip system, or a processor that supports the terminal to implement the above method, or a chip, a chip system, or a processor that supports the network device to implement the above method. The apparatus may be used to implement the method described in the above method embodiments, and the details may be referred to the description in the above method embodiments.

The communication apparatus 1300 may include one or more processors 1301. The processor 1301 may be a general purpose processor or a special purpose processor, for example, a baseband processor or a central processing unit. The baseband processor may be used to process communication protocols and communication data, and the central processing unit may be used to control communication apparatuses (such as a base station, a baseband chip, a terminal, a terminal chip, a DU or a CU, etc.), execute computer programs, and process computer program data.

Optionally, the communication apparatus 1300 may also include one or more memories 1302 for storing the computer program 1304. The processor 1301 executes the computer program 1304, which may cause the communication apparatus 1300 to implement the method in the above method embodiments. Optionally, the memory 1302 may also store data. The communication apparatus 1300 and the memory 1302 may be set up separately or integrated together.

Optionally, the communication apparatus 1300 may also include a transceiver 1305 and an antenna 1306. The transceiver 1305 may be called a transceiver unit, a transceiver machine, or a transceiver circuit, etc., to implement the receiving and sending function. The transceiver 1305 may include a receiver and a transmitter, and the receiver may be called a receiving machine or a receiving circuit, etc. to realize the receiving function; and the transmitter may be called a transmitting machine or a transmitting circuit, etc. to realize the sending function.

Optionally, the communication apparatus 1300 may also include one or more interface circuits 1307. The interface circuit 1307 is used to receive code instructions and transmit the code instructions to the processor 1301. The processor 1301 runs the code instructions to cause the communication apparatus 1300 to implement the method in the above method embodiment.

In one implementation, the processor 1301 may include a transceiver for implementing the receiving and sending function. For example, the transceiver may be a transceiver circuit, or an interface, or an interface circuit. The transceiver circuit, the interface, or the interface circuit used to perform the receiving and sending function may be separate or integrated. The transceiver circuit, the interface or the interface circuit may be used for reading and writing code/data, or the transceiver circuit, the interface or the interface circuit may be used for the transmission of signals.

In one implementation, the processor 1301 may store a computer program 1303. When the computer program 1303 is running on the processor 1301, the communication apparatus 1300 is caused to implement the method in the above method embodiments. The computer program 1303 may be solidified in the processor 1301, in which case the processor 1301 may be implemented in hardware.

In an implementation, the communication apparatus 1300 includes a circuit that may implement the transmitting or receiving or communicating function in the above method embodiments. The processor and transceiver in the disclosure may be implemented in an integrated circuit (IC), an analog IC, a radio frequency integrated circuit (RFIC), a mixed-signal IC, an application specific integrated circuit (ASIC), a printed circuit board (PCB), an electronic equipment, etc. The processor and transceiver may also be manufactured with various IC process technologies, such as a complementary metal oxide semiconductor (CMOS), nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication apparatus in the above embodiments may be a terminal (such as the terminal in the method embodiments) or a network device (such as the first network device and/or the second network device in the above method embodiments), but the scope of the communication apparatus in the disclosure is not limited to this, and the structure of the communication apparatus may not be restricted by FIG. 16. The communication apparatus may be an independent device or part of a larger device. For example, the communication apparatus may be:
(1) an independent IC, or a chip, or a chip system or a subsystem;
(2) a collection including one or more IC, optionally, the IC collection may also include storage components for storing data and computer programs;
(3) an ASIC, such as a modem;
(4) modules embedded in other devices;
(5) a receiver, a terminal, an intelligent terminal, a cellular phone, a wireless device, a handheld phone, a mobile unit, a vehicle-mounted device, a network device, a cloud device, an artificial intelligence device, etc.;
(6) others.

For the case where the communication apparatus may be a chip or a chip system, please refer to the structural diagram of a chip in FIG. 17. The chip shown in FIG. 17 includes a processor 1401 and an interface 1402. There may be one or more processors 1401, and there may be one or more interfaces 1402.

For the situation that the chip is used to perform the functions of the UE in the embodiments of the present disclosure:
the interface 1402 is configured to receive code instructions and transmit the code instructions to the processor;
the processor 1401 is used to execute the code instructions to implement any method as shown in FIG. 2 to FIG. 4.

For the situation that the chip is used to perform the functions of the network device (such as the first network device in the foregoing method embodiments) in the embodiments of the present disclosure:
the interface 1402 is configured to receive code instructions and transmit the code instructions to the processor;
the processor 1401 is used to execute the code instructions to implement any method as shown in FIG. 5 to FIG. 6.

For the situation that the chip is used to perform the functions of the network device (such as the second network device in the foregoing method embodiments) in the embodiments of the present disclosure:
the interface 1402 is configured to receive code instructions and transmit the code instructions to the processor;
the processor 1401 is used to execute the code instructions to implement any method as shown in FIG. 7 to FIG. 8.

Optionally, the chip also includes a memory 1403, which is used to store necessary computer programs and data.

Those skilled in the art may also understand that the various illustrative logical blocks and steps listed in the embodiments of the present disclosure may be implemented by electronic hardware, computer software, or their combination. Whether such a function is implemented in hardware or software depends on specific applications and design requirements of the overall system. Those skilled in the art may, for each specific application, use a variety of methods to achieve the above function, but such implementation shall not be regarded as going beyond the scope of the protection of the embodiments of the present disclosure.

In the embodiments of the present disclosure, a readable storage medium for storing instructions is provided. When the instructions are executed by a computer, the function of any one of the above method embodiments is performed.

In the embodiments of the present disclosure, a computer program product is provided. When the computer program product is executed by a computer, the function of any one of the above method embodiments is performed.

In the above embodiments, the functions may be wholly or partially implemented by software, hardware, firmware, or any combination of them. When implemented by software, the functions may be implemented in whole or in part in the form of a computer program product. The computer program product includes one or more computer programs. Procedures or functions according to embodiments of the present disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another website, computer, server, or data center via wire (such as a coaxial cable, a fiber optic, a digital subscriber line (DSL)) or wireless (such as infrared, wireless, microwave). The computer-readable storage medium may be any available medium that may be accessed by a computer, or a data storage device such as a server that integrates one or more of the available media, and a data center. The available medium media be a magnetic medium (such as a floppy disk, a hard disk and a magnetic tape), an optical medium (such as a digital video disk (DVD)), or a semiconductor medium (such as a solid state disk (SSD)).

Those skilled in the art may understand that numbers like “first” and “second” in the present disclosure are only for the convenience of description, and are not used to limit the scope of the embodiments of the present disclosure, and also indicate a sequential order.

The term “at least one” in the present disclosure may also be described as one or more, and the more may be two, three, four, or more, which is not limited in the present disclosure. In the embodiment of the present disclosure, for a technical feature, the technical feature in the technical features is distinguished by terms “first”, “second”, “third”, “A”, “B”, “C” and “D”, etc., and the technical features described by the terms “first”, “second”, “third”, “A”, “B”, “C” and “D”, etc. are not in a sequential order or in an order of size.

It should be understood that, although the terms first, second, third, etc. may be used to describe various information in the embodiments of the present disclosure, the information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the term “if” as used herein may be interpreted as “at the time of” or “when” or “in response to determining”. For the purpose of brevity and ease of understanding, the terms used herein when characterizing the size relationship are “greater than” or “less than”, “higher than” or “lower than”. However, for those skilled in the art, it can be understood that the term “greater than” also covers the meaning of “greater than or equal to”, the term “less than” also covers the meaning of “less than or equal to”, the term “higher than” covers the meaning of “higher than or equal to”, and the term “lower than” also covers the meaning of “lower than or equal to”.

Corresponding relationships indicated by tables in the present disclosure may be configured or predefined. Values of information in the tables are only examples, and may be configured as other values, which are not limited in the disclosure. When the corresponding relationship between information and parameters is configured, it is not always necessary to configure all corresponding relationships indicated in tables. For example, in the tables of the present disclosure, corresponding relationships indicated by some rows may not be configured. For another example, appropriate transformations and adjustments, such as splitting and merging, may be made based on the above tables. Names of parameters shown in headers of the tables may be other names understandable by the communication apparatus, and values or representations of the parameters may be other values or representations understandable by the communication apparatus. When the above tables are implemented, other data structures may be used, for example, arrays, queues, containers, stacks, linear lists, pointers, linked lists, trees, graphs, structures, classes, heaps or hash tables may be used.

Predefined in the disclosure may be understood as defined, predefined, stored, pre-stored, pre-negotiated, pre-configured, solidified or pre-fired.

Those skilled in the related art may realize that, in combination with units and algorithm steps of the examples described in embodiments of the present disclosure, may be implemented by an electronic hardware or a combination of an electronic hardware and a computer software. Whether the functions are executed by the hardware or the software depends on a specific application and a design constraint of the technical solutions. Those skilled in the art may adopt different methods for each specific application to implement the described functions, but such implementation should not be considered as going beyond the scope of the present disclosure.

Those skilled in the art may clearly understand that, a specific working process of a system, an apparatus and a unit described above may refer to a corresponding process in the above method embodiments, which will not be repeated here.

The above are only implementations of the disclosure. However, the protection scope of the disclosure is not limited here. Changes and substitutions that may be easily considered by those skilled in the art shall be contained within the protection scope of the present disclosure. Therefore, the protection scope of the disclosure shall be subject to the protection scope of claims.

1. A control method, performed by a user equipment (UE), comprising:
receiving an assistance operation rule sent by a first network device to the UE; and
assisting in performing quality of service (QoS) control on at least one of an uplink or a downlink of the UE according to status information of the UE and the assistance operation rule.

2. The method of claim 1, wherein assisting in performing the QoS control on at least one of the uplink or the downlink of the UE based on the status information of the UE and the assistance operation rule comprises:
sending assistance operation information to the first network device according to the status information of the UE and the assistance operation rule.

3. The method of claim 2, wherein
the assistance operation information is used to: make a policy decision, or perform the QoS control on at least one of an uplink data flow or a downlink data flow of the UE; or
the assistance operation information comprises: at least one of a decision or a requirement generated by the UE based on the status information and the assistance operation rule.

4-5. (canceled)

6. The method of claim 1, further comprising:
determining whether to assist in making a policy decision or performing the QoS control according to the status information of the UE.

7. (canceled)

8. The method of claim 1, further comprising one of:
sending a first message to a third network device according to the status information of the UE and the assistance operation rule;
wherein the first message is used for the third network device to determine a data flow suitable for the QoS control and/or related information of the QoS control required by the data flow; or
sending a second message to the third network device according to the status information of the UE and the assistance operation rule; wherein the second message is used to notify the third network device to stop performing the QoS control assisted by the UE.

9. (canceled)

10. The method of claim 1, wherein the status information comprises at least one of:
device temperature information;
device overheating information;
battery life information;
power supply mode information;
remaining battery level information;
remaining available battery time information; or
central processing unit (CPU) load information.

11. (canceled)

12. The method of claim 1, wherein the assistance operation rule comprises at least one of:
a UE status assistance operation mode;
a UE status assistance operation mode indication;
a threshold;
a UE status assistance operation function;
a priority; or
an importance;
wherein
the UE status assistance operation mode indicates at least one of a data flow or a parameter for which the first network device performs the QoS control based on assistance of the UE; or
the UE status assistance operation mode indication indicates an operation mode of at least one QoS control performed by the first network device based on assistance of the UE, wherein the operation mode comprises at least one of: load balancing; power consumption balancing; packet data unit (PDU) set based QoS handling; slicing reselection; or extended reality and multimedia (XRM) coordination; or
the threshold indicates an indicator threshold for the first network device to perform the QoS control; or
the threshold comprises at least one of: a maximum round trip time (RTT); a maximum packet loss rate; a guaranteed traffic bit rate (GFBR) threshold; or an aggregate maximum bit rate (AMBR) threshold; or
the UE status assistance operation function indicates whether an operation mode of at least one QoS control performed by the first network device based on assistance of the UE is applied to a data flow matching the UE status assistance operation mode; or
the priority or the importance indicates whether a data flow for which the first network device performs the QoS control needs to comply with at least one of a preset priority or a preset importance level.

13-19. (canceled)

20. A control method, performed by a first network device, comprising:
sending an assistance operation rule to a user equipment (UE), wherein the assistance operation rule is used for the UE to assist in performing quality of service (QoS) control on at least one of an uplink or a downlink of the UE according to status information of the UE.

21. The method of claim 20, further comprising:
receiving assistance operation information sent by the UE, wherein the assistance operation information is generated by the UE according to the status information of the UE and the assistance operation rule.

22. The method of claim 21, further comprising at least one of:
making a policy decision or performing the QoS control on an uplink data flow of the UE based on the assistance operation information; or
making a policy decision or performing the QoS control on a downlink data flow of the UE based on the assistance operation information.

23. The method of claim 21, wherein
the assistance operation information comprises: at least one of a decision or a requirement generated by the UE based on the status information and the assistance operation rule.

24. The method of claim 23, wherein the assistance operation information further comprises the status information of the UE.

25. The method of claim 20, wherein
the status information comprises at least one of:
device temperature information;
device overheating information;
battery life information;
power supply mode information;
remaining battery level information;
remaining available battery time information; or
central processing unit (CPU) load information; or
the assistance operation rule is carried in a policy and charging control (PCC) rule.

26-27. (canceled)

28. The method of claim 20, wherein the assistance operation rule comprises at least one of:
a UE status assistance operation mode;
a UE status assistance operation mode indication;
a threshold;
a UE status assistance operation function;
a priority; or
an importance.

29. The method of claim 28, wherein
the UE status assistance operation mode indicates at least one of a data flow or a parameter for which the first network device performs the QoS control based on assistance of the UE; or
the UE status assistance operation mode indication indicates an operation mode of at least one QoS control performed by the first network device based on assistance of the UE, wherein the operation mode comprises at least one of: load balancing; power consumption balancing; packet data unit (PDU) set based QoS handling; slicing reselection; or extended reality and multimedia (XRM) coordination; or
the threshold indicates an indicator threshold for the first network device to perform the QoS control; or
the threshold comprises at least one of: a maximum round trip time (RTT); a maximum packet loss rate; a guaranteed traffic bit rate (GFBR) threshold; or an aggregate maximum bit rate (AMBR) threshold; or
the UE status assistance operation function indicates whether an operation mode of at least one QoS control performed by the first network device based on assistance of the UE is applied to a data flow matching the UE status assistance operation mode; or
the priority or the importance indicates whether a data flow for which the first network device performs the QoS control needs to comply with at least one of a preset priority or a preset importance level.

30-35. (canceled)

36. A control method, performed by a second network device, comprising:
receiving a policy and charging control (PCC) rule sent by a first network device, wherein the PCC rule comprises an assistance operation rule; and
sending the assistance operation rule to a user equipment (UE), wherein the assistance operation rule is used to assist in performing quality of service (QoS) control on at least one of an uplink or a downlink of the UE according to status information of the UE.

37. The method of claim 36, further comprising:
sending an N4 rule to a third network device based on the PCC rule, wherein the N4 rule is used for routing of a session of the UE in at least one of an uplink direction or a downlink direction.

38-40. (canceled)

41. A communication apparatus, comprising a processor and a memory;
wherein the memory stores a computer program, and the processor executes the computer program stored in the memory to cause the communication apparatus to perform the method of claim 1.

42. A communication apparatus, comprising a processor and a memory;
wherein the memory stores a computer program, and the processor executes the computer program stored in the memory to cause the communication apparatus to perform the method of claim 20.

43. A communication apparatus, comprising a processor and a memory;
wherein the memory stores a computer program, and the processor executes the computer program stored in the memory to cause the communication apparatus to perform the method of claim 36.

44-49. (canceled)
